(19) United States
(12) Patent Application Publication
(10) Pub. No.: US 2016/0305581 A1
(43) Pub. Date: Oct. 20, 2016

(54) FUEL TRANSPORT HOSE AND METHOD

(71) Applicant: Cadillac Rubber & Plastics, Inc., Cadillac, MI (US)

(72) Inventors: Michael K. Fauble, Cadillac, MI (US); Brent C. Dahlquist, Cadillac, MI (US); Michael L. Anderson, Cadillac, MI (US)

(21) Appl. No.: 15/091,386

(22) Filed: Apr. 5, 2016

Related U.S. Application Data
(60) Provisional application No. 62/147,796, filed on Apr. 15, 2015.

(51) Int. Cl. F16L 11/12; B67D 7/04

(52) U.S. Cl. CPC F16L 11/12; B67D 7/04

(57) ABSTRACT

A fuel transport hose has an FKM inner layer, a CPT barrier layer, and a tie layer between the inner layer and the barrier layer, bonded to an outer surface of the inner layer and bonded to an inner surface of the barrier layer.

### CROSS REFERENCE TO RELATED APPLICATIONS

This application claims priority to U.S. Application Ser. No. 62/147,796, filed Apr. 15, 2015, the entire disclosure of which is incorporated herein.

### BACKGROUND OF THE INVENTION

1. Field of the Invention

This invention relates to hydrocarbon impermeable elastomeric tubes and hoses. In one of its aspects, the invention relates to a method for manufacturing hydrocarbon impermeable elastomeric tubes and hoses for use, for example, in automotive fuel filler hoses and automotive fuel tubes. In another of its aspects, the invention relates to laminated structures having flexibility, impact resistance and hydrocarbon impermeability suited for use as a fuel and/or vapor conducting hoses and tubes.

2. Description of the Related Art

Multilayered or laminated rubber hoses serve as fuel transporting hoses for an automotive fuel feed line into a vehicle reservoir. The conduit wall may have three layers; a heat and gasoline-resistant inner tube; a weather-resistant outer tube and a reinforcing fiber matrix or layer interposed and integrated between the other two. Even so, partly oxidized, or “sour” gasoline and oxygenated fuel adversely affect a fuel hose life so that enhanced gasoline-resistant features are needed. The fluoropolymer FKM, a terpolymer of tetrafluoroethylene, hexafluoropropylene and vinylidine chloride, hereinafter, respectively, TFE, HFE, and VF2, has exhibited satisfactory performance characteristics as a fuel resistant material. See, for example, U.S. Pat. No. 5,093,166, issued Mar. 3, 1992. However, it has proved difficult to bond an FKM layer to other rubbers. Further, FKM layers are not by themselves sufficiently impermeable to hydrocarbon vapors to enable automobile manufacturers to meet current U.S. EPA standards for automotive vehicle emissions manufactured since 1995.

The U.S. Pat. No. 5,941,286 to Fauble et al. discloses a laminated rubbery tubular structure that includes the cooperative use of two fluoropolymeric materials having complementary physical properties and incorporating an adjacent layer of a rubbery polymer such as an epichlorohydrin elastomer used as an amorphous copolymer with ethylene oxide (ECO), all of which can be extruded in a continuous process to provide a resilient and bendable tubular article of very low hydrocarbon permeability, and is further well adapted for transport of volatile fuels. The tubular sidewall comprises a core layer of an FKM fluoroelastomer, exhibiting the properties of a rubber, a second layer of THV fluoroplastic exhibiting the properties of a thermoplastic layer, these layers being relatively thin layers, and an external layer of a rubbery polymer such as an epichlorohydrin monomer (EC) copolymerized with ethylene oxide (EO) to form an epichlorohydrin polymer (ECO). This ECO layer is the relatively thicker layer in the laminate. The core layer of FKM includes a measurable amount of an electroconductive filler material, like carbon black, useful to confer the desired core layer with conductivity for discharge of static electricity. A tie layer of an amine or an acrylic compound can be coated onto the THV layer to bond the THV layer to the ECO layer.

The Fauble et al. published patent application US2007/0065616 discloses a multi-layered fuel transport hose comprising an FKM inner layer, a THV barrier layer, a binder layer and rubber outer layer. The binder layer may be any suitable binding material such as amine or acrylic compounds. The FKM layer and THV layer act in concert to provide the hydrocarbon barrier. The multi-layered hose may also contain a reinforcement layer. This patent discloses the use of FKM as the conductive rubber layer and the use of FKM in combination with a THV layer to provide the required vapor barrier properties. In addition the Fauble et al. '286 patent discloses a hose construction comprising an FKM layer, a THV layer, a binder layer and an outer rubber layer.

Jing et al. U.S. Pat. No. 6,197,393 discloses a multi-layer article having a fluoropolymer layer that exhibits the quality of bonding to a non-fluorinated polymer as the intermediate layer that can bind to both the non-fluorinated polymer on one side and a fluoropolymer on the other side and exhibits the desired vapor barrier properties. Instead of utilizing a single layer to achieve the necessary bonding strength and vapor barrier properties, a composite layer consisting of individual components that possess each desired property may be used.

Since 1979, methyl tert-butyl ether (MTBE) has been used in U.S. gasoline to replace lead as an octane enhancer. MTBE is used to oxygenate the gasoline to improve engine performance and emissions. Ethanol is an example of another chemical that can be added to gasoline to act as an oxygenate. MTBE has been the most common fuel additive, mainly due to its ease of transport and because it is less volatile than ethanol. MTBE's decreased volatility compared to ethanol makes it easier for manufacturers of fuel components, fueling stations and fuel transporters to meet U.S. EPA hydrocarbon emission requirements. However, the U.S.EPA has unveiled plans to phase out the use of MTBE additives in fuel. In addition, the California Air Resources Board (CARE) has plans to change their test standards for determining hydrocarbon permeability from a test that uses CARB Phase II fuel containing MTBE to CARB LEV III fuel which uses ethanol as an additive. Ethanol substantially increases the permeation rates for materials commonly used in fuel storage systems. Fuel systems, comprising multiple components such as fuel storage reservoirs and fuel transport hoses, which may have met U.S.EPA standards for permeability when tested with fuel containing MTBE, may not be able to meet the permeability requirements when tested with fuel containing ethanol. Reduced hydrocarbon permeability can be achieved in part by reducing the hydrocarbon permeability of individual components of a fuel system, one such component being fuel transport hoses. Therefore, there is a need in the industry for improved fuel transport hoses which have minimal hydrocarbon permeability when tested with fuel containing ethanol.

### SUMMARY OF EMBODIMENTS OF THE INVENTION

According to an embodiment of the invention, a fuel transport hose has an elastomeric inner layer formed of an FKM fluoropolymer; an elastomeric barrier layer formed of a CPT fluoropolymer; and a tie layer between the inner layer and the barrier layer, bonded to an outer surface of the inner layer and bonded to an inner surface of the barrier layer.

According to another embodiment of the invention, a method for forming a fuel transport hose includes co-extruding an FKM inner layer and an NBR tie layer through a first extrusion die to form a first multilayer tubing; extruding a CPT barrier layer onto the first multi-layer tubing through a second extrusion die to form a second multilayer tubing; cooling the second multilayer tubing; extruding a second tie layer onto the outer surface through a third extrusion die; and applying a cover layer onto the second tie layer to form a third multilayer tubing.

### BRIEF DESCRIPTION OF THE DRAWINGS

In the drawings:

FIG. 1 is a perspective view of an embodiment of a fuel transport hose according to a first embodiment of the invention.

FIG. 2 is a cross-sectional view of the fuel transport hose of FIG. 1 taken along lines 2-2 of FIG. 1.

FIG. 3 is a schematic representation of a process according to the invention for making the fuel transport hose of FIGS. 1 and 2.

FIG. 4 is cross-section view of a fuel hose assembly according to another embodiment of the invention.

FIG. 5 is chart illustrating the results of evaporative emissions testing according to an embodiment of the invention.

### DESCRIPTION OF EMBODIMENTS OF THE INVENTION

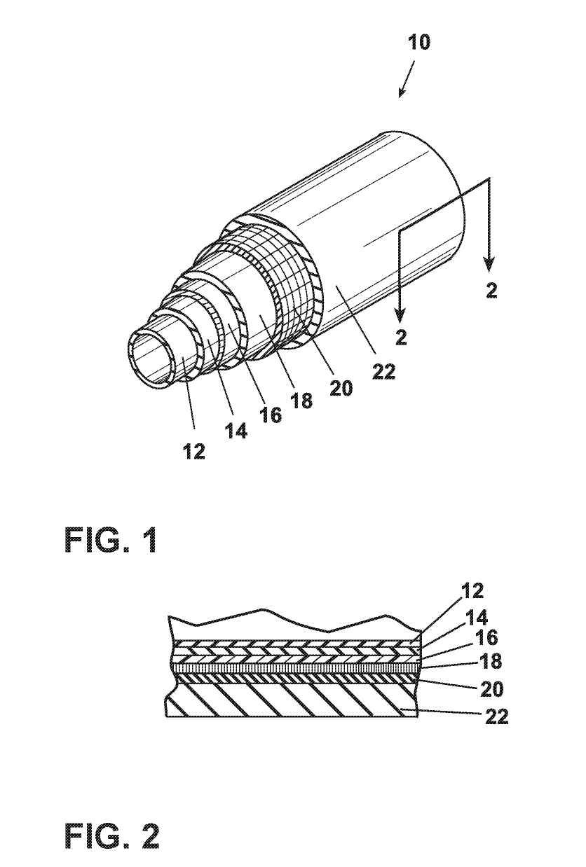

Referring now to the drawings and to FIGS. 1 and 2 in particular, an embodiment of a fuel transport hose 10 for transporting volatile hydrocarbons is shown according to the invention. For the purposes of description related to the figures, the terms “inner” and “outer” are made with reference to a central axis of the hose 10. The hose 10 includes an inner fuel resistant layer 12, a barrier layer 16, a rubber layer 18, an optional reinforcing layer 20, and a cover layer 22. A tie layer 14, also referred to as an adhesive or binder layer, can be provided between the inner layer 12 and the barrier layer 16 to bind these layers together.

The inner layer 12 comprises a resin that preferably has a thickness in the range of 0.0005 to 0.035 inches and is preferably made from FKM (according to the ASTM D1418 standard), e.g., a terpolymer of tetrafluoroethylene, hexafluoropropylene and vinylidene fluoride, or a copolymer of tetrafluoroethylene and hexafluoropropylene.

The barrier layer 16 comprises a fluorine-containing resin having a thickness in the range of 0.0001 to 0.050 inches. Preferably the fluorine-containing resin is a perfluoroalkoxy alkane-based (PFA-based) co-polymer. In a preferred embodiment, the barrier layer 16 comprises chlorotrifluoroethylene-perfluoroalkoxy tetrafluoroethylene co-polymer (CPT). The barrier layer 16 can be treated to promote bonding by removing fluorine atoms from the surface of the fluorine-containing resin. Non-limiting examples of treatments to promote bonding include treatment with a sodium metal complex, plasma treatment, corona discharge treatment, or chemical etching.

The rubber layer 18 is formed over an outer surface of the barrier layer 16 and preferably has one or more of the following properties: ozone and weather resistance, moderate fuel resistance, flame resistance and it must adhere to the barrier layer 16. The material used in the rubber layer 18 can be selected from various vulcanizable elastomeric compounds of any known natural rubber or synthetic rubber stock non-limiting examples of which include hydrogenated nitrile butadiene (HNBR), epichlorohydrin (ECO), chlorosulphonated polyethylene (CSM), chlorinated polyethylene (CPE), polyacrylate rubber (ACM), ethylene-acrylate rubber (AEM), polychloroprene (CR), acrylonitrile butadiene (NBR), acrylonitrile butadiene polyvinyl chloride (NBR/PVC), and ethylene propylene diene monomer (EPDM) or combinations thereof. The rubber layer 18 can also contain a fluxed fiber which is intended to provide increased strength to the hose construction, non-limiting examples of which include nylon, polyester, aramid, and natural fibers (rayon, cotton, and the like). In a preferred embodiment, the rubber layer 18 can also act as a tie layer to bond an outer surface of the barrier layer 16 with an inner surface of the adjacent layer, which in the embodiment of FIG. 1 is the reinforcing layer 20. A preferred material for a rubber tie layer 18 is a layer of a nitrile rubber or acrylic rubber.

The tie layer 14 is configured to bond an outer surface of the inner layer 12 with an inner surface of the barrier layer 16, and can be made from any suitable binder material to promote adhesion of the adjacent layers. In one embodiment, tie layer 14 is made from a layer of a nitrile rubber or acrylic rubber. In a preferred embodiment, the tie layer 14 is made from a layer of NBR. The tie layer 14 generally has a thickness of about 0.0005 to 0.060 inches.

The optional reinforcing layer 20 can be any type of woven or knit fabric layers and are well known in the reinforced rubber hose field. The cover layer 22 can be made from made from epichlorohydrin (ECO), chlorosulphonated polyethylene (CSM), chlorinated polyethylene (CPE), ethylene-acrylate rubber (AEM), polychloroprene (CR), or acrylonitrile butadiene polyvinyl chloride (NBR/PVC). In one example, the cover layer 22, can include a reinforcing fabric layer that can be knitted, braided, or spiraled between two rubber layers. The reinforcing fiber can be selected from: nylon, polyester, aramid, and natural fibers (rayon, cotton, etc.).

By way of example, the fuel transport hose of FIGS. 1 and 2 can have dimensional values in the ranges given in Table I below.

TABLE I
Exemplary dimensional ranges for the fuel transport hose.

| Fuel Filler | Inches |
|---|---|
| ID Range | 0.500-1.750 |

| | Inches | | |
|---|---|---|---|
| Wall Composition | Nominal | Upper Limit | Lower Limit |
| Inner Layer | 0.020 | 0.050 | 0.0005 |
| Tie Layer | 0.020 | 0.050 | 0.0005 |
| Barrier Layer | 0.004 | 0.020 | 0.0005 |
| Tie Layer | 0.032 | 0.150 | 0.015 |
| Cover Layer | 0.084 | 0.250 | 0.015 |
| Total Target Wall | 0.160 | — | — |

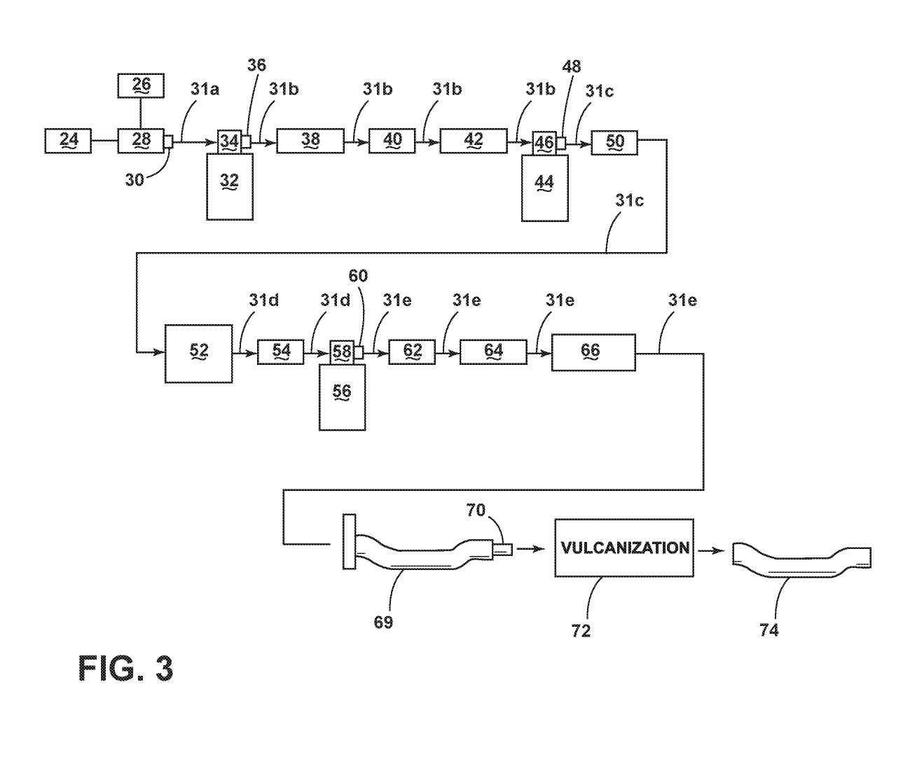

Referring now to FIG. 3, there is shown in schematic form a process for producing a fuel transport hose according to an embodiment of the invention. An inner layer extruder 24 and tie layer extruder 26 are coupled with a dual extrusion head 28 to co-extrude the inner layer 12 and the tie layer 14 through an extrusion die 30 to form a multi-layer tubing 31a having an inner fuel resistant layer 12 and an outer tie layer 14. In an exemplary embodiment, the inner layer 12 can be an FKM layer with an NBR tie layer 14 co-extruded onto an outer surface thereof. A barrier layer extruder 32 and extrusion head 34 extrude a CPT barrier layer onto the multi-layer tubing 31a through an extrusion die 36 to form a multi-layer tubing 31b having an FKM inner fuel resistant layer and an outer CPT barrier layer with an NBR tie layer in between. The multi-layer tubing 31b is then pulled through a cooling tank 38 by a puller 40. The multi-layer tubing 31b is then passed through a surface treatment stage 42 that treats an outer surface of the CPT barrier layer 16 to facilitate adhesion of the next layer. As discussed above, the barrier layer 16 can be treated with a sodium metal complex, plasma treatment, corona discharge treatment, or chemical etching. In a preferred embodiment in which the barrier layer 16 is made from CPT, the outer surface of the CPT barrier layer 16 can be treated with chemical etching. Chemical etching can include a surface treatment using a solvent that contains a base, a non-limiting example of which includes 1,8-diazabicyclo[5.4.0]undec-7-ene (DBU).

A tie layer extruder 44 and tie layer extrusion head 46 extrude a second tie layer 18 onto the outer surface of the multi-layer tubing 31b through an extrusion die 48 to form a multi-layer tubing 31c. The multi-layer tubing 31c is then pulled by a puller 50 to an optional reinforcement station 52 at which a reinforcing layer 20 can be applied to the outer surface of the multi-layer tubing 31c to form multi-layer tubing 31d. The multi-layer tubing 31d can then pass through an adhesive applicator 54 which applies an adhesive to the outer surface of the multi-layer tubing 31d. A cover layer extruder 56 and cover layer extrusion head 58 then extrude a cover layer 22 onto the outer surface of the multi-layer tubing 31d through an extrusion die 60 to form a multi-layer tubing 31e having an inner FKM layer 12, a first tie layer 14, a CPT barrier layer 16, a second tie layer 18, a reinforcing layer 20, and a cover layer 22. A puller 62 pulls the multi-layer tubing 31e with the extruded cover layer 22 thereon to a cooling tank 64. Alternatively, rather than extruding the cover layer 22 onto the multi-layer tubing 31d, the cover layer 22 can be in the form of a strip of material that is wrapped around the circumference of the multi-layer tubing. In this alternative process, the optional reinforcing layer 20 can be applied to the multi-layer tubing prior to application of the cover layer 22 or the reinforcing layer 20 can be pre-assembled with the cover layer 22.

Once all of the layers have been applied, the multi-layer tubing 31 is then cut to lengths at a cutting machine 66 in a well-known operation. The lengths of multi-layer tubing 31e are then placed onto a shaping device having a mandrel 70 to give a shape to the tubing 31e to provide a pre-form 69 of the multi-layer fuel transport hose 10. The shaped tubing pre-form 69 is then vulcanized in a vulcanizing autoclave chamber 72 to form the multi-layer fuel transport hose 10. After vulcanization, the thus formed multi-layer fuel transport hose 10 is removed from the mandrel 70 and subsequently cooled to provide the final, vulcanized multi-layer fuel transport hose 10.

The thus formed multi-layer transport hose 10 is adaptable to be formed into various shapes such as the tubular article of FIG. 1, shown after extrusion by the method of the invention, but seen prior to its shaping and vulcanization to adapt to a particular auto fuel filler or vapor management tube. The resulting resilient articles of variable lengths, and of differing configurations (such as may be due to the internal geometry of the vehicles in which the fuel transport hose is installed), provide an organic chemical and weather-resistant fluid conduit, permitting only negligible escape of volatile hydrocarbon vapors, due to enhanced sidewall gas impermeability.

Evaporative Emissions Testing

Hose Construction

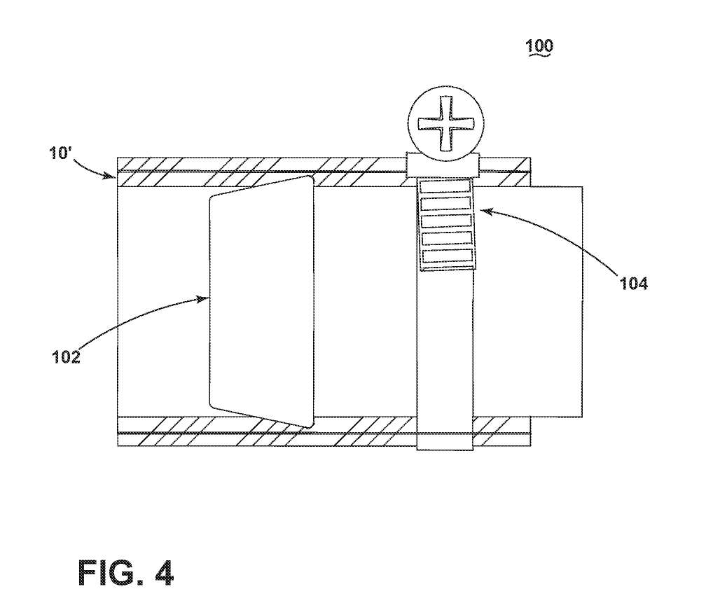

FIG. 4 illustrates an exemplary fuel transport hose assembly 100 formed using an exemplary fuel transport hose 10′ (“Exemplary Hose Assembly”) for use in evaporative emissions testing. The fuel transport hose 10′ is made from an inner fuel resistant layer of FKM, an NBR tie layer, a CPT barrier layer, an NBR tie layer, and a cover layer, in that order, according to the embodiments of the invention described above. A hose connecter 102 is inserted into an open end of the fuel hose 10′ and secured using a hose clamp 104.

Comparative hose assemblies were assembled in a similar manner using different fuel transport hoses as shown in Table II. The thickness of the barrier layer in each hose assembly was 0.127 mm, with a total internal diameter of 31 mm and a length of 150 mm.

TABLE II
Comparative Fuel Hose Construction

| | Multi-layer Construction |
|---|---|
| Comparative Fuel Hose | (inner layer/barrier layer/tie layer/cover layer) |
| Comparative Example 1 | NBR/THV815G*/NBR/Cover Layer |
| Comparative Example 2 | FKM/THV815G*/NBR/Cover Layer |
| Comparative Example 3 | NBR/CPT/NBR/Cover Layer |

*THV815G is a high grade THV resin commercially available from 3M ™ under the trademark Dyneon.

Evaporative Emissions Test Method

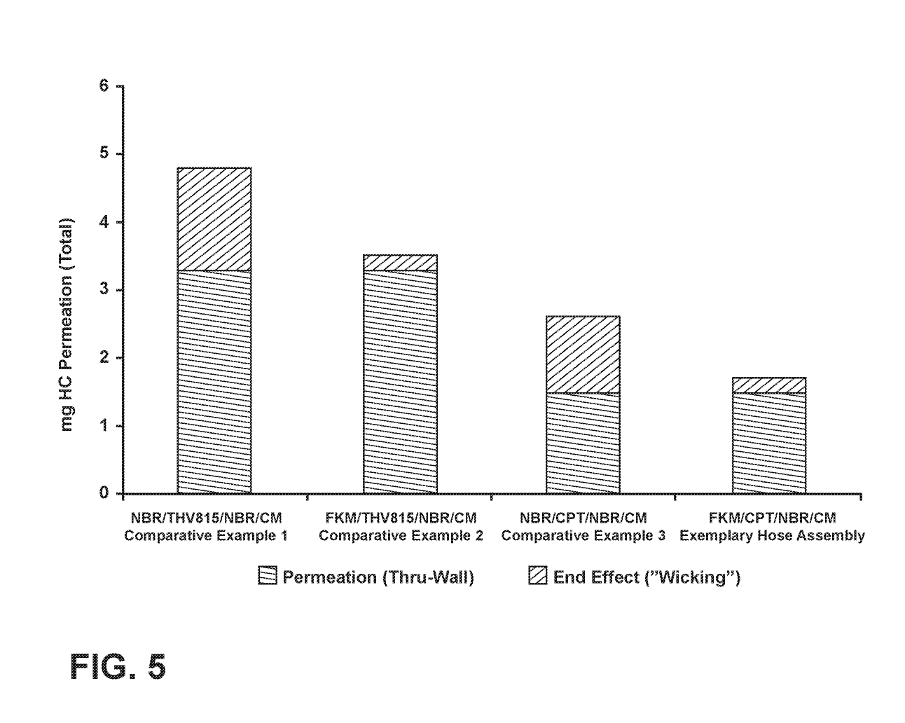

The Exemplary Hose Assembly and Comparative Example fuel transport hoses were tested according to the California Air Resources Board (CARE) diurnal emissions test as set forth in the State of California Air Resources Board “California Evaporative Emission Standards and Test Procedures for 2001 and Subsequent Model Motor Vehicles,” as amended Dec. 6, 2012. The test involves assembling hoses to a container of fuel and aging the hoses for a period of 26 weeks. The fuel used is CARB LEV III, which includes 10% ethanol as an additive. During the aging period, the hoses are inverted to make sure that the inside of the hoses are exposed to liquid fuel. After the aging period, the hoses and fuel container are placed in a small sealed chamber with the hoses being upright so that the inside of the hose is exposed to only fuel vapor. The temperature of the chamber is then raised from 18° C. to 41° C. and then back to 18° C. over a 24 hour period. During this 24 hour period, the air in the chamber is being sampled into an analyzer to determine the mass of hydrocarbons present in the air. The total amount of hydrocarbons for the 24 hour period was determined and the results are shown in FIG. 5. Measurements were taken at the beginning of the test (0 weeks), 6 weeks, 12 weeks, and 26 weeks.

At the beginning of the test, the measured amount of hydrocarbons is primarily representative of initial leakage at the hose joints. The amount of hydrocarbons as a result of leakage decreases over time as the hose seals against the fittings. The hydrocarbon values at 6, 12, and 26 weeks are representative of a combination of permeation (defined as fuel evaporation through the wall of the hose), leakage (defined as fuel evaporation through a non-designed hole, breach, or scratch), and hose end-effect permeation that results from the inner material absorbing fuel and releasing it out the end of the hose (also known as “wicking”).

At the end of the 26 week period, the hose joints are sealed with epoxy and the test is repeated. By doing this, the only emission coming from the hose is permeation (through the hose wall). The difference in the hydrocarbon amount at 26 weeks before sealing and 26 weeks after sealing is the emission coming from the end of the hose either through leakage or hose end-effect permeation (wicking).

FIG. 5 illustrates the results for the Comparative Examples 1-3 as well as the projected results for the Exemplary Hose Assembly based on initial data. FIG. 5 demonstrates that hose assemblies that include NBR as the inner layer have larger hydrocarbon emissions from hose end-effect permeation (wicking) than hose assemblies that include FKM as the inner layer. Preliminary data for the Exemplary Hose Assembly which includes an FKM inner layer and a CPT barrier layer indicates that the Exemplary Hose Assembly has a lower hydrocarbon emission from hose end-effect permeation (wicking) than the Comparative Examples 1 and 2 which utilize THV 815G as the barrier layer. The preliminary data for the Exemplary Hose Assembly also indicates that the fuel transport hose having the combination of an FKM inner layer and a CPT barrier layer has lower total hydrocarbon emissions than the Comparative Examples 1-3 made using NBR or FKM as the inner layer and THV 815G or CPT as the barrier layer.

The exemplary fuel transport hose described herein combines the low permeation characteristics of a perfluoroalkoxy alkane-based barrier layer, such as CPT, with the low permeation characteristics of an FKM inner layer to provide a hose with decreased permeation characteristics compared to more traditional fuel transport hoses. CPT can be difficult to bond to materials such as FKM. Attempts to bond CPT directly to the FKM layer were unable to provide adequate adhesion between the two layers for use in a fuel transport hose. Applicants have found that CPT can be bonded with FKM through the use of a tie layer, such as NBR. The tie layer can be co-extruded with the FKM inner layer to provide the FKM inner layer with an outer substrate to which the CPT can bond with sufficient strength to provide the desired low permeation characteristics. The CPT barrier layer can be treated to promote adhesion of additional materials to an outer surface of the CPT barrier layer such that a multi-layer hose can be formed.

In addition to decreased hydrocarbon permeation characteristics, the exemplary fuel transport hose described herein using an FKM inner fuel resistant layer and a perfluoroalkoxy alkane-based barrier layer, such as CPT, can have a cost benefit compared to many traditional fuel transport hoses. Consider as an example, a traditional fuel transport hose made from an FKM inner layer, a THV 815G barrier layer, an NBR tie layer and a cover layer, in that order. The exemplary hose described herein can utilize a thinner FKM inner fuel resistant layer than the traditional example because the FKM is being co-extruded with an NBR tie layer. The thickness of the FKM layer in the traditional construction typically was on the order of 0.030-0.035 inches, whereas in the exemplary hose construction, the co-extruded FKM layer has a thickness of only 0.020 inches. The decreased material usage involved in a thinner layer of FKM can provide cost savings compared to the traditional hose while offering comparable or improved hydrocarbon permeation characteristics.

To the extent not already described, the different features and structures of the various embodiments of the invention may be used in combination with each other as desired. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A fuel transport hose comprising an elastomeric inner layer formed of an FKM fluoropolymer; an elastomeric barrier layer formed of a CPT fluoropolymer; and a tie layer between the inner layer and the barrier layer, bonded to an outer surface of the inner layer and bonded to an inner surface of the barrier layer.

2. The fuel transport hose of claim 1 wherein the tie layer is one of a nitrile rubber or an acrylic rubber.

3. The fuel transport hose of claim 2 wherein the tie layer is NBR.

4. The fuel transport hose of claim 1 wherein an outer surface of the barrier layer is treated so as to remove fluorine atoms.

5. The fuel transport hose of claim 1 wherein the inner layer comprises a resin having a thickness in the range of 0.0005 to 0.035 inches.

6. The fuel transport hose of claim 1 wherein the barrier layer comprises a resin having a thickness in the range of 0.0001 to 0.050 inches.

7. The fuel transport hose of claim 1 wherein the tie layer has a thickness of about 0.0005 to 0.060 inches.

8. The fuel transport hose of claim 1 further comprising a rubber layer formed over and adhered to an outer surface of the barrier layer.

9. The fuel transport hose of claim 8 further comprising a reinforcing layer formed over and adhered to an outer surface of the rubber layer.

10. The fuel transport hose of claim 9 further comprising a cover layer formed over and adhered to an outer surface of the reinforcing layer.

11. A method of forming a fuel transport hose comprising:
co-extruding an FKM inner layer and an NBR tie layer through a first extrusion die to form a first multilayer tubing;
extruding a CPT barrier layer onto the first multi-layer tubing through a second extrusion die to form a second multilayer tubing;
cooling the second multilayer tubing;
treating an outer surface of the CPT barrier layer to remove fluorine atoms;
extruding a second tie layer onto the outer surface through a third extrusion die; and
applying a cover layer onto the second tie layer to form a third multilayer tubing.

12. The method of claim 11 further comprising applying a reinforcement layer to the second tie layer, and applying and adhesive to the reinforcement layer before applying the cover layer.

13. The method of claim 11 wherein the cover layer is applied by one of extrusion or wrapping.

14. The method of claim 11 further comprising cutting the third multilayer tubing into predetermined lengths.

15. The method of claim 11 further comprising shaping one of the second multilayer tubing or third multilayer tubing on a shaping device.

16. The method of claim 16 wherein the shaping device is mandrel.

17. The method of claim 11 further comprising vulcanizing the third multilayer tubing.
